(19) United States
(12) Patent Application Publication
(10) Pub. No.: US 2014/0000101 A1
(43) Pub. Date: Jan. 2, 2014

(54) METHODS AND APPARATUS TO FORM PRINTED BATTERIES ON OPHTHALMIC DEVICES

(71) Applicant: JOHNSON & JOHNSON VISION CARE, INC., Jacksonville, FL (US)

(72) Inventors: Randall B. Pugh, Jacksonville, FL (US); Daniel B. Otts, Fruit Cove, FL (US); Katherine Hardy, Jaksonville, FL (US); Frederick A. Flitsch, New Windsor, NY (US)

(73) Assignee: Johnson & Johnson Vision Care, Inc., Jacksonville, FL (US)

(21) Appl. No.: 13/835,785

(22) Filed: Mar. 15, 2013

Related U.S. Application Data
(60) Provisional application No. 61/665,970, filed on Jun. 29, 2012.

(51) Int. Cl. B29D 11/00

(52) U.S. Cl. CPC B29D 11/00817
USPC 29/623.2

(57) ABSTRACT

This invention discloses methods and apparatus to form energization elements upon electrical interconnects on Three-dimensional Surfaces. In some embodiments, the present invention includes incorporating the Three-dimensional Surfaces with electrical interconnects and energization elements into an insert for incorporation into ophthalmic Lenses. In some embodiments, the formed insert may be directly used as an ophthalmic Lens.

### CROSS REFERENCE TO RELATED APPLICATIONS

This application claims priority to the U.S. Provisional Application No. 61/665,970, filed Jun. 29, 2012, the contents of which are relied upon and incorporated herein.

### FIELD OF USE

This invention describes methods and apparatus operant to form a device whereon energization elements can be defined upon electrical interconnections. In some embodiments, the methods and apparatus to form energization elements relate to said formation upon electrical interconnection surfaces that occur on substrates that have Three-dimensional Surfaces. In some embodiments, a field of use for the methods and apparatus may include ophthalmic Lenses that incorporate energization elements.

### BACKGROUND

Traditionally, an ophthalmic Lens, such as a contact Lens, an intraocular Lens, or a punctal plug, included a biocompatible device with a corrective, cosmetic, or therapeutic quality. A contact Lens, for example, may provide one or more of vision correcting functionality, cosmetic enhancement, and therapeutic effects. Each function is provided by a physical characteristic of the Lens. A design incorporating a refractive quality into a Lens may provide a vision corrective function. A pigment incorporated into the Lens may provide a cosmetic enhancement. An active agent incorporated into a Lens may provide a therapeutic functionality. Such physical characteristics are accomplished without the Lens entering into an Energized state. A punctal plug has traditionally been a passive device.

More recently, it has been theorized that active components may be incorporated into a contact Lens. Some components may include semiconductor devices. Some examples have shown semiconductor devices embedded in a contact Lens placed upon animal eyes. It has also been described how the active components may be Energized and activated in numerous manners within the Lens structure itself. The topology and size of the space defined by the Lens structure creates a novel and challenging environment for the definition of various functionalities. In many embodiments, it is important to provide reliable, compact, and cost effective means to energize components within an ophthalmic Lens. In some embodiments, these energization elements may include batteries that may also be formed from “alkaline” cell-based chemistry.

Technological embodiments that address such an ophthalmological background may need to generate solutions that not only address ophthalmic requirements but also encompass novel embodiments for the more general technology space of defining energization elements upon interconnections that are within or upon devices that have a Three-dimensional Surface.

### SUMMARY

Accordingly, the present invention includes methods and apparatus to define energization elements upon electrical interconnections that are formed upon Three-dimensional Surfaces, which may be included as inserts into a finished ophthalmic Lens. In some embodiments, an insert is provided that may be Energized and incorporated into an ophthalmic Lens.

The insert may be formed in a number of manners that can result in a Three-dimensional Surface upon which electrical interconnections may be formed. Subsequently, energization elements may be formed in contact with or upon these electrical interconnections. For example, in some embodiments, the energization elements may be formed by applying Deposits containing battery-cell-related chemicals to the electrical interconnections. The application may be performed, for example, by a printing process in which mixtures of the chemicals can be applied using dispensing needles or other application tools. The novel devices thus formed are an important aspect of the inventive art disclosed herein.

In some embodiments, the details of the energization element construction can provide important design aspects for the devices. Adhesion of the various Deposits can be challenging, especially for the embodiments that involve wet chemical electrolytes. As a result, some embodiments may enhance adhesion by a change in surface roughness of the substrate used, for example, by electrical discharge machining (EDM) texture on plastic, by including patterned current collectors, or both. Patterns may include, for example, different protrusions and gaps in the Electrode layers that may enhance adhesion. In some embodiments, different Deposit compositions may also be relevant to construction for robust performance.

The chemical composition of the various Deposit layers provides additional inventive art. The presence and amounts of various Binders and Fillers may also be relevant. Additionally, in some embodiments, the unique microscopic characteristics of chemical constituents of the battery Electrodes may also be important. Accordingly, the present invention includes a disclosure of a technological framework for forming and defining energizing elements upon interconnections upon Three-dimensional Surfaces. In exemplary embodiments, disclosure is made for an ophthalmic Lens with an insert upon which energizing components are attached and interconnected by metal, metal-containing, or otherwise conductive lines defined upon the surface of the insert; and an apparatus for forming an ophthalmic Lens with energizing elements upon electrical interconnections defined upon Three-dimensional Surfaces and methods for the same.

### DESCRIPTION OF THE DRAWINGS

FIG. 1 illustrates an exemplary substrate with Three-dimensional Surfaces upon which interconnections may be defined.

FIG. 2 illustrates an exemplary cross-sectional depiction of energization elements on interconnections on a Three-dimensional Substrate.

FIG. 3 illustrates an example of forming energization elements on a Three-dimensional Substrate by a printing means.

FIG. 4 illustrates a top down depiction of an exemplary battery element construction.

FIG. 5 illustrates of an alternative exemplary design for conductive Traces operant for formation of energization elements with enhanced adhesion characteristics.

FIG. 6 illustrates exemplary methods steps to form energization elements on Three-dimensional Surfaces.

### DETAILED DESCRIPTION OF THE INVENTION

The present invention relates to methods and apparatus useful to the formation of energization elements upon electrical interconnects that are upon surfaces having three-dimensional topology. In the following sections, detailed descriptions of embodiments of the invention will be given. The description of both preferred and alternative embodiments are exemplary embodiments only, and it is understood that to those skilled in the art that variations, modifications, and alterations may be apparent. It is therefore to be understood that said exemplary embodiments do not limit the scope of the underlying invention.

### Glossary

In this description and claims directed to the presented invention, various terms may be used for which the following definitions will apply:

“Anode” as used herein refers to an Electrode through which electric current flows into a polarized electrical device. The direction of electric current that is typically opposite to the direction of electron flow. In other words, the electrons flow from the Anode into, for example, an electrical circuit.

“Binder” as used herein refers to a polymer that is capable of exhibiting elastic responses to mechanical deformations and that is chemically compatible with other battery components. For example, it may include electroactive materials, electrolyte, and current collectors.

“Cathode” as used herein refers to an Electrode through which electric current flows out of a polarized electrical device. The direction of electric current that is typically opposite to the direction of electron flow. Therefore, the electrons flow into the polarized electrical device and out of, for example, the connected electrical circuit.

“Deposit” as used herein refers to any application of material, including, for example, a coating or a film.

“Electrode” as used herein can refer to an active mass in the Energy Source. For example, it may include one or both of the Anode and Cathode.

“Encapsulate” as used herein refers to creating a barrier completely surrounding an entity for the purpose of containing specified chemicals within the entity and preventing specific substances, such as, for example, water, from entering the entity.

“Encapsulant” as used herein refers to any substance, composite, or mixture that completely surrounds an entity for the purpose of containing specified chemicals within the entity and preventing specific substances, such as, for example, water, from entering the entity.

“Energized” as used herein refers to the state of being able to supply electrical current to or to have electrical Energy stored within.

“Energy Harvesters” as used herein refers to devices capable of extracting Energy from the environment and converting it to electrical Energy.

“Energy Source” as used herein refers to any device or layer that is capable of supplying Energy or placing a logical or electrical device in an Energized state.

“Energy” as used herein refers to the capacity of a physical system to do work. Many uses within this invention may relate to the said capacity of being able to perform electrical actions in doing work.

“Filler” as used herein refers to one or more battery separator that does not react with either acid or alkaline electrolytes. Generally, Fillers may be substantially water insoluble and operable, including, for example, carbon black, coal dust and graphite, metal oxides and hydroxides such as those of silicon, aluminum, calcium, magnesium, barium, titanium, iron, zinc, and tin; metal carbonates such as those of calcium and magnesium; minerals such as mica, montmorollonite, kaolinite, attapulgite, talc; synthetic and natural zeolites, Portland cement; precipitated metal silicates such as calcium silicate; hollow microspheres, and flakes and fibers; polymer microspheres; glass microspheres.

“Functionalized” as used herein refers to making a layer or device able to perform a function including for example, energization, activation, or control.

“Lens” as used herein refers to any device that resides in or on the eye. The device may provide optical correction, may be cosmetic, or provide some functionality unrelated to optic quality. For example, the term Lens may refer to a contact Lens, intraocular Lens, overlay Lens, ocular insert, optical insert, or other similar device through which vision is corrected or modified, or through which eye physiology is cosmetically enhanced (e.g. iris color) without impeding vision. Alternatively, Lens may refer to a device that may be placed on the eye with a function other than vision correction, such as, for example, monitoring of a constituent of tear fluid or means of administering an active agent. In some embodiments, the preferred Lenses of the invention may be soft contact Lenses that are made from silicone elastomers or hydrogels, which may include, for example, silicone hydrogels and fluorohydrogels.

“Lens-forming Mixture” or “Reactive Mixture” or “RMM” as used herein refer to a monomeric composition and/or prepolymer material that may be cured and cross-linked or cross-linked to form an ophthalmic Lens. Various embodiments may include Lens-forming mixtures with one or more additives such as UV blockers, tints, diluents, photoinitiators or catalysts, and other additives that may be useful in an ophthalmic Lenses such as, contact or intraocular Lenses.

“Lens-Forming Surface” as used herein refers to a surface that can be used to mold a Lens. In some embodiments, any such surface can have an optical quality surface finish, which indicates that it is sufficiently smooth and formed so that a Lens surface fashioned by the polymerization of a Lens forming material in contact with the molding surface is optically acceptable. Further, in some embodiments, the Lens-forming Surface may have a geometry that may be necessary to impart to the Lens surface the desired optical characteristics, including, for example, spherical, aspherical and cylinder Power, wave front aberration correction, and corneal topography correction.

“Mold” as used herein refers to a rigid or semi-rigid object that may be used to form Lenses from uncured formulations. Some preferred Molds include two Mold parts forming a front curve Mold part and a back curve Mold part, each Mold part having at least one acceptable Lens-Forming Surface.

“Optical Zone” as used herein refers to an area of an ophthalmic Lens through which a user of the ophthalmic Lens sees.

“Power” as used herein refers to work done or Energy transferred per unit of time.

“Rechargeable” or “Re-energizable” as used herein refers to a capability of being restored to a state with higher capacity to do work. Many uses within this invention may relate to the capability of being restored with the ability to flow electrical current at a certain rate for certain, reestablished time periods.

“Reenergize” or “Recharge” as used herein refers to restoring to a state with higher capacity to do work. Many uses within this invention may relate to restoring a device to the capability to flow electrical current at a certain rate for certain, reestablished time periods.

“Released” or “Released from a Mold” as used herein refers to a Lens that is either completely separated from the Mold or is only loosely attached so that it may be removed with mild agitation or pushed off with a swab.

“Stacked Integrated Component Devices” or “SIC Devices” as used herein refers to the product of packaging technologies that assemble thin layers of substrates, which may contain electrical and electromechanical devices, into operative integrated devices by means of stacking at least a portion of each layer upon each other. The layers may comprise component devices of various types, materials, shapes, and sizes. Furthermore, the layers may be made of various device production technologies to fit and assume various contours.

“Stacked” as used herein refers to the placement at least two component layers in proximity to each other such that at least a portion of one surface of one of the layers contacts a first surface of a second layer. In some embodiments, a Deposit, whether for adhesion or other functions, may reside between the two layers that are in contact with each other through said Deposit.

“Substrate Insert” as used herein refers to a formable or rigid substrate that can be capable of supporting an Energy Source and may be placed on or within an ophthalmic Lens. In some embodiments, the Substrate Insert also supports one or more components.

“Three-dimensional Surface” or “Three-dimensional Substrate” as used herein refers to any surface or substrate that has been three-dimensionally formed where the topography is designed for a specific purpose, in contrast to a planar surface.

“Trace” as used herein refers to a battery component capable of electrically connecting the circuit components. For example, circuit Traces may include copper or gold when the substrate is a printed circuit board and may be copper, gold, or printed Deposit in a flex circuit. Traces may also be comprised of nonmetallic materials, chemicals, or mixtures thereof.

Devices with Three-Dimensional Surfaces with Incorporated Energization Devices.

The methods and apparatus related to at least portions of the inventive art presented herein relate to forming energization elements within or on Three-dimensional Substrates with electrical interconnects upon surfaces of a Three-dimensional Substrate.

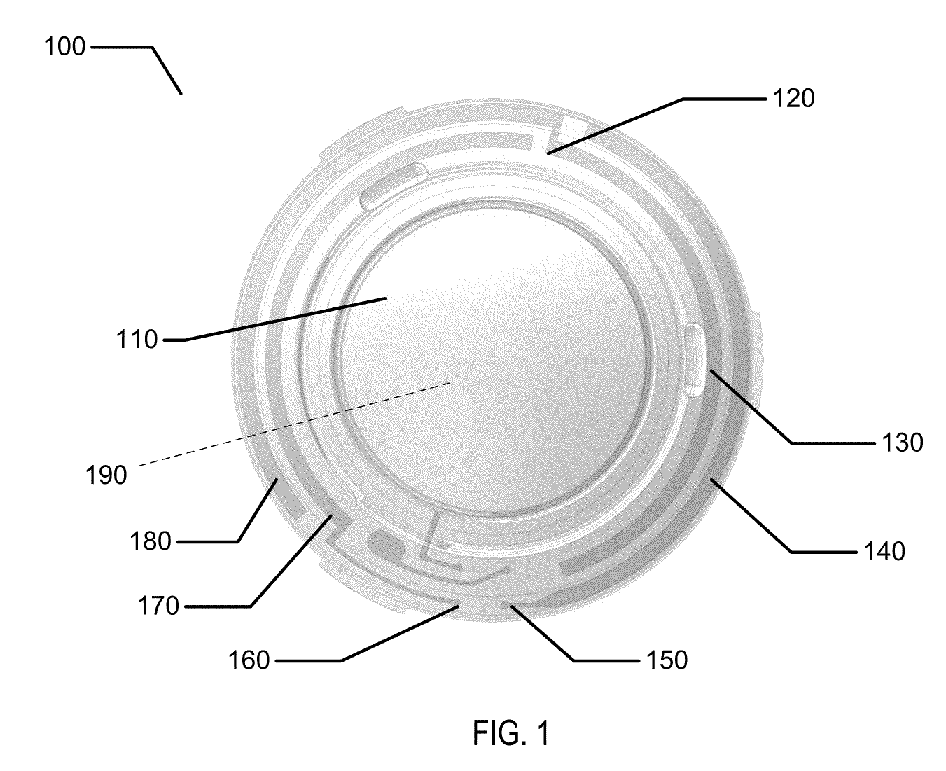

Referring to FIG. 1, an exemplary Three-dimensional Substrate 100 with electrical Traces is depicted. In some embodiments, the ophthalmic Lens may include an active focusing element. Such an active focusing device may function by utilizing Energy that may be stored in an energization element. The Traces 130, 140, 170, and 180 upon the Three-dimensional Substrate 100 may additionally provide a substrate to form energization elements upon.

In the exemplary ophthalmic Lens, the Three-dimensional Substrate may include, for example, an optically active region 110. In some embodiments wherein the device has a focusing element, the optically active region 110 may represent a front surface of an insert device that contains the focusing element through which light can pass on its way into a user's eye. Such embodiments include a peripheral region of the ophthalmic Lens that may not be used as an optically relevant path. In some embodiments, said peripheral region may contain the components related to the active focusing function. These components may be electrically connected to each other by metal Traces. These metal Traces may also provide conductivity and additional useful functions, including for example, supporting the incorporation of energizing elements into the ophthalmic Lens.

In some embodiments, the energization element may be a battery, including, for example, a solid-state battery or a wet cell battery. In embodiments where the energization element is a battery, at least two electrically conductive Traces 170 and 140 may allow an electrical potential to form between the Anode 150 and the Cathode 160 of the battery, providing energization to the active elements in the device. For exemplary purposes, the Anode 150 represents the (−) potential connection of an energization element to incorporated devices, and the Cathode 160 represents the (+) potential connection of an energization element to incorporated devices.

In some embodiments, isolated Traces 140 and 170 may be located proximate to neighboring Traces 130 and 180. The neighboring Traces 130 and 180 may represent an opposite polarity Electrode or chemistry type when battery elements are produced upon these Traces 130 and 180. For example, a neighboring Trace 130 may be connected to a chemical layer allowing the neighboring Trace 130 to function as a Cathode of a battery cell defined by the components on the isolated Trace 140 and the neighboring Trace 130.

In some embodiments, two Traces 130 and 180 may connect to each other through a Trace region 120. The Trace region 120 may not be coated with an active chemical layer, allowing the Trace region 120 to function as an electrical interconnection.

This exemplary embodiment illustrates the electrical Traces 130, 140, 170, and 180 where two pairs of electrical cells may be configured as batteries connected in series. The total electrical performance across the connections 150 and 160 may be a combination of two battery cells.

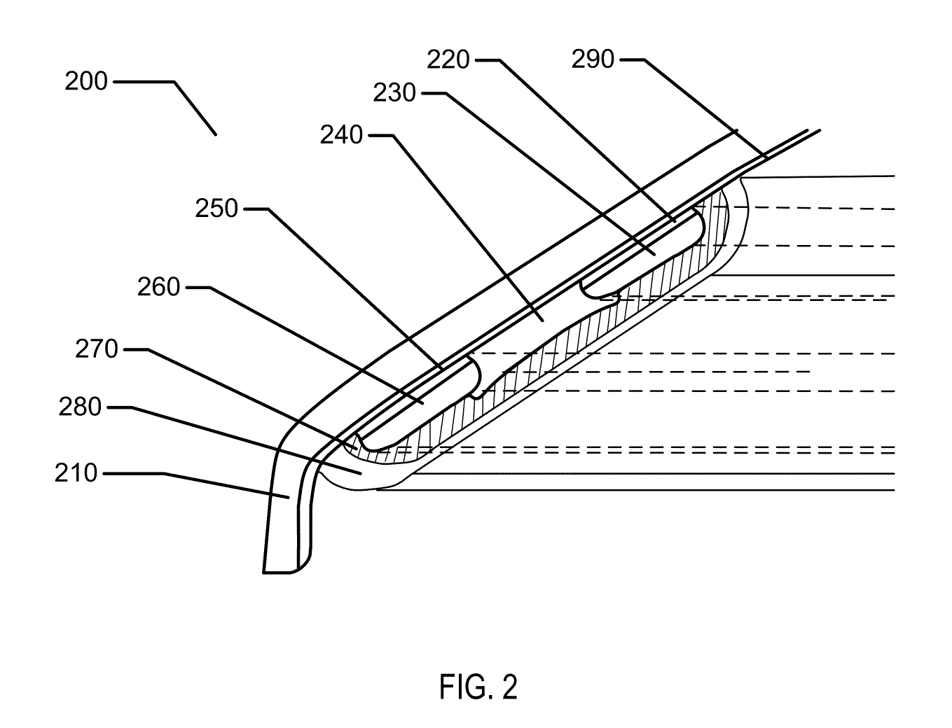

Proceeding to FIG. 2, an exemplary embodiment of a cross sectional representation of energization elements upon the exemplary Traces of the Three-dimensional Substrate 200 is depicted. The Three-dimensional Substrate 200 is a cross sectional representation of FIG. 1 along the dotted line 190. Accordingly, the electrical Traces 180 and 130 of FIG. 1 are included in cross sectional views of Traces 250 and 220 in FIG. 2.

In some embodiments, the base material 210 of the Three-dimensional Substrate may have a thin coating layer 290. The Three-dimensional Surface with electrical Traces 250 and 220 may then be formed into representative battery elements. In some embodiments, for example, by applying or coating a Deposit layer, an Anode layer 260 may be formed and deposited upon an electrical Trace 250, and a Cathode layer 230 may be formed and deposited upon an electrical Trace 220. The combination of the Anode layer 260 and the Cathode layer 230 may comprise important components of a battery.

In some exemplary battery designs, the two elements 260 and 230 may be arranged in a coplanar and separated configuration. In some other embodiments, a bridge layer 240 may connect and at least partially coat the Cathode layer 230 and the Anode layer 260. In said embodiments, the bridge layer 240 may be a porous insulating layer through which ionic diffusion may occur.

In a wet cell type of battery, the Electrolyte for the battery cell may be formed by combining solvent, such as an aqueous solution, and other chemicals. In some embodiments, the aqueous or wet electrolyte layer 240 may be Encapsulated or sealed with a primary Encapsulant 270, which may connect and seal to the substrate layers 290 and 210. In some embodiments, a secondary Encapsulant layer 280, such as parylene-C, may be included, wherein a combination of these layers 270 and 280, when deployed across the surface of the Three-dimensional Substrate 200 surface, may define a formed energization element.

It may be obvious to one skilled in the art that numerous embodiments of energization elements may be practical, and such devices are well within the scope of the inventive art. Therefore, while the cross sectional Three-dimensional Substrate 200 may represent an exemplary structure for an alkaline-type wet cell battery, other types of energization elements including, for example, solid-state batteries may be appropriate in some other embodiments.

### Forming Energization Elements by Printing Techniques

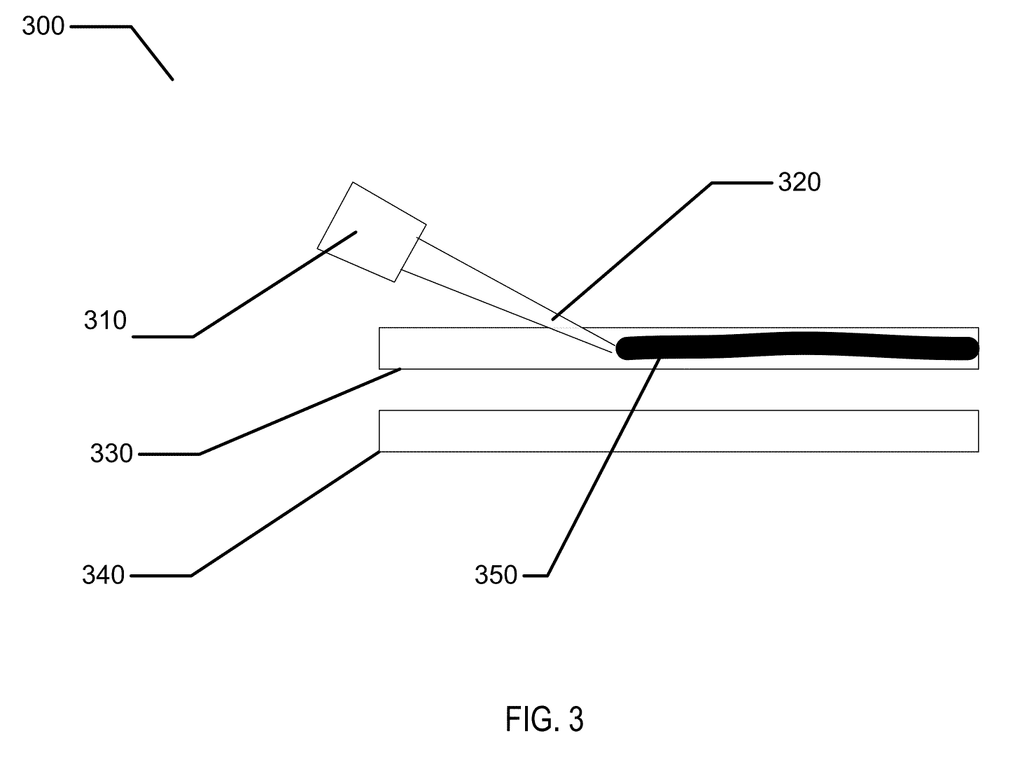

Proceeding to FIG. 3, an illustration of forming energization elements by printing techniques is depicted. As used herein, the phrase “printing techniques” is broadly represented by the process of depositing or leaving a Deposit of material in defined locations. Although descriptions included herein may focus on “additive” techniques where the material is placed at certain isolated locations upon a Three-dimensional Surface topology, one skilled in the art may recognize that “subtractive” techniques, where a coating layer may be subsequently patterned to allow for the removal of material in selected locations resulting in a pattern of isolated locations, is also within the scope of the art herein.

In some embodiments of printing techniques 300, a printing means 310 interacts with electrical Traces 330 and 340. In some embodiment, the printing means 310 may have a printing head 320 that may control the distribution of material into a defined, localized region. In some simple embodiments, the printing head 320 may include a stainless steel needle that may have an exit orifice size between 150 microns to 300 microns. Some exemplary reference numbers that may enable the printing include, for example, precision stainless steel tips from Nordson EFD for Cathode and Anode printing, more specifically 25 gauge, 27 gauge, 30 gauge or 32 gauge by 1.4″ length tip. In some embodiments, other examples may include SmoothFlow™ tapered tips or EFD Ultimus™ model number 7017041.

The printing means 310 may contain and be loaded with a mixture of a variety of active and supportive materials to result in various components of an energization element. These combinations of materials may contain an active battery Anode or Cathode materials in microscopic powder form. The various compounds may be processed in sorting manners to result in a mixture that may have a small controlled distribution of sizes of the powder constituents. In some exemplary embodiments, one Anode mixture may contain a zinc powder formulation comprising only powder components small enough to pass through a 25-micron sieve. By restricting the components in size by various techniques, including for example sieving, the size of the orifice of a print head may be made to be very small (e.g. 200 microns or 150 microns) in some embodiments.

Table 1 includes examples of mixtures of components for a printable Anode formulation. Alternatively, Table 2 provides exemplary mixtures for a printable Cathode formulation. Table 3 includes exemplary mixtures for a printable bridge element formulation. In addition to the active components, the mixtures in these tables may also include a variety of solvents, Fillers, Binders, and other types of additional components. To one ordinarily skilled in the art, it may be obvious that numerous modifications to the makeup, constituents, amounts of materials, nature of the components of the materials, and other changes may be appropriate and is well within the scope of the present invention.

TABLE 1a
Exemplary Anode Mixture

| Material | Function/Description |
|---|---|
| PE_600k 5.5% soln' (hot water method) | diluted Binder |
| Grillo Zn GC 2-0/200Bi/200In | <25 μm Zn powder |
| Aerosil R972 | Rheology modifier/stabilizer |
| Timcal KS6 graphite | conductive particle |
| PEG600, 10% (w/w) in DI | plasticizer, corrosion inhibitor |
| Triton X-100, 10% (w/w) in DI | surfactant |

TABLE 1b
Exemplary Anode Mixture

| Material | Function/Description |
|---|---|
| Poly(ethylene oxide), Mv = 600k 5.5% | diluted Binder |
| (w/w) in DI water' | |
| Zinc alloy powder with 200 ppm Bi, | <25 μm sieve analysis, active |
| 200 ppm Indium | anode |
| Aerosil R972 | Rheology modifier/stabilizer |
| Poly(ethylene glycol) Mn = 600 g/mol, | plasticizer, Zn corrosion |
| 10% (w/w) in DI water | inhibitor |
| Triton X-100, 10% (w/w) in DI water | surfactant |

TABLE 2a
Exemplary Cathode Mixture

| Material | Function |
|---|---|
| PEO_600k 5.2% soln' (hot water method) | diluted Binder |
| MnO2, Erachem, unsieved | Cathode active material |
| Aerosil R972 | rheology modifier |
| Silver flake, Ferro SF120 | conductive additive |
| Triton X-100, 10% (w/w) in DI | surfactant |

TABLE 2b
Exemplary Cathode Mixture

| Material | Function |
|---|---|
| Poly(ethylene oxide), Mv = 600k 5.5% | diluted Binder |
| (w/w) in DI water' | |
| Electrolytic manganese dioxide powder | active cathode |
| Aerosil R972 | rheology modifier |
| Silver flake | conductive additive |
| Triton X-100, 10% (w/w) in DI | surfactant |

TABLE 3
Exemplary Binder “Bridge” Separator

| Material | Function |
|---|---|
| PEO_600k 5.5% soln' (hot water method) | diluted Binder |
| Barium Sulfate | Filler, solid |
| Aerosil R972 | rheology modifier |
| PEG600, 10% (w/w) in DI | plasticizer, corrosion inhibitor |
| Triton X-100, 10% (w/w) in DI | surfactant |

TABLE 3b
Exemplary Binder “Bridge” Separator

| Material | Function |
|---|---|
| Poly(ethylene oxide), Mv = 600k 5.5% | diluted Binder |
| (w/w) in DI water' | |
| Barium Sulfate | Filler, solid |
| Aerosil R972 | rheology modifier |
| Poly(ethylene glycol) Mn = 600 g/mol, | plasticizer, corrosion inhibitor |
| 10% (w/w) in DI water | |
| Triton X-100, 10% (w/w) in DI | surfactant |

In some embodiments, when the printing means 310 is loaded with a material, its printing head 320 may be moved relative to the substrate or the substrate may move relative to the printing head 320, by the control mechanisms of the printing means 310 to locate the printing head in a three-dimensional location above a defined electrical Trace 330. In some embodiments, for example, the printing means 310 may utilize an nScrypt device, 3Dn-TABLETOp™. As the substrate is moved relative to the printing head 320 over the correct three-dimensional path, the printing head 320 may be configured to dispense some of the chemical mixture from the printer.

In some embodiments, as the printing process occurs, a line or combination of lines or dots may be formed into an appropriate printed feature 350 upon a current collector 330. As the process occurs, different patterns of varied chemical mixtures may be printed upon the Three-dimensional Substrate. Depending on the purpose of the printed feature 350 and the embodiment, printing may occur above regions with current collectors and above regions without Traces.

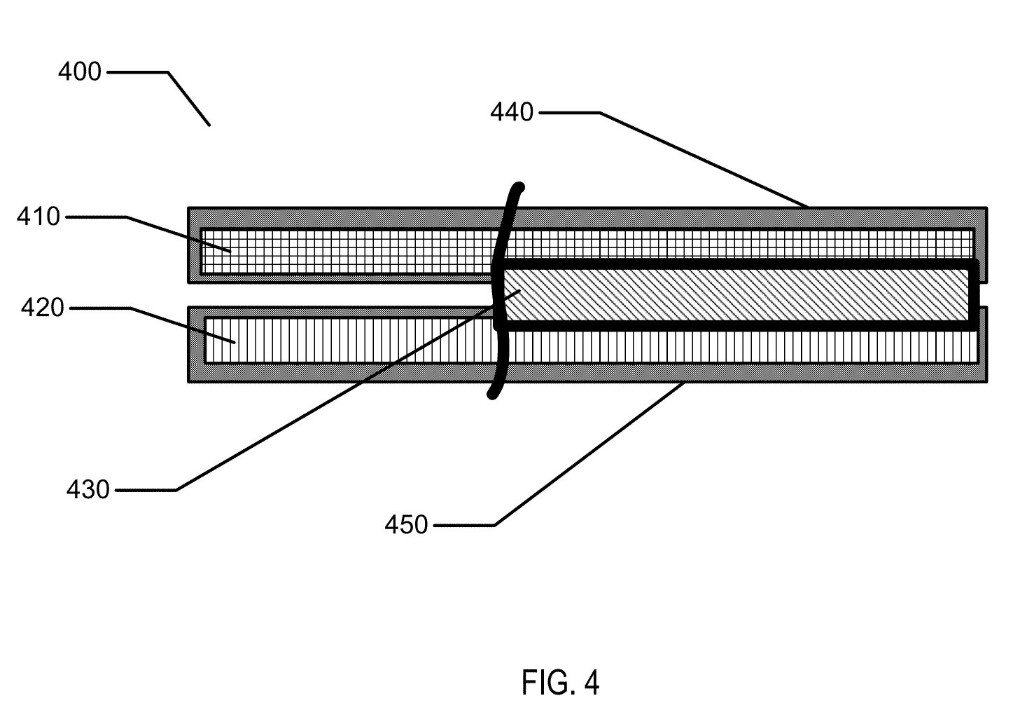

Proceeding to FIG. 4, an example 400 of a printed energization element upon a Three-dimensional Surface containing electrical Traces is illustrated where the Electrode layers are shown smaller than their respective electrical Traces. In some other embodiments, printed layers may completely cover or even to a degree transcend the Traces. In some exemplary embodiments, printed features may lie upon Traces. For example, an Anode feature 410 may be printed upon an electrical Trace 440, and a Cathode feature 420 may be printed upon an electrical Trace 450. Some embodiments may include another printed feature 430 in a region that is centered above a portion of the Three-dimensional Surface where there is no electrical Trace. For example, the other printed feature 430 may be a bridge layer between the Anode feature 410 and the Cathode feature 420.

The printing means and energization elements herein described are illustrated for exemplary purposes only, and one ordinarily skilled in the art will recognize that means and elements other than those discussed may also be included within the scope of the invention. For example, in some alternatives, it may be possible to deposit an Anode layer across the entire Three-dimensional Surface. In other alternative embodiments, subtractive processing methods, such as, for example, lithography processes and subtractive etch processing, may be used to remove the Deposit except where necessary. In still further embodiments, the printing means may include a combination of subtractive and additive techniques, such as, for example, where the Anode and Cathode layers are deposited as layers and subtractively removed while the bridge component may be formed by a printing process as an example.

### Aspects of the Design of Traces for Exemplary Energization Elements

Wet cell alkaline batteries represent a complex example of an energization element that may be useful for the inventive art herein. In some such embodiments, among the constituents of this type of batteries, the electrolyte formulations may have basic (as opposed to acidic) characteristics. Adhesion of the various constituents to each other may be an important requirement in certain embodiments. In addition, in the presence of basic aqueous solutions, some Deposit combinations may have better adhesion than other combinations, and some Trace designs may allow for better adhesion than other designs.

For example, the initial surface of the Three-dimensional Substrate may be coated with a Deposit of material that may change its surface properties. In some embodiments, the Three-dimensional Substrate may be a surface that may be hydrophobic in nature. A coating of this Three-dimensional Substrate with parylene Deposit may provide adherence characteristics between the substrate and the parylene Deposit and may also thereafter have an altered surface characteristic.

In embodiments where Traces may be formed upon the parylene Deposit, which are also hydrophobic in character, the aqueous Deposit may be repelled from any interface. An example of a Trace formulation with such hydrophobic character may be Traces formed from silver impregnated pastes, such as, for example, conductive epoxy. These Traces may contain a significant amount of silver flakes, which may have relatively low resistance and, due to the hydrophobic character of the Traces, may form Traces that can help provide sufficient adherence to underlying parylene Deposits. To those skilled in the art, it will be clear that these Traces of silver impregnated paste may be formed using the printing means discussed in previous sections as well. In alternative embodiments, the design of the Traces may have physical characteristics that may enhance adhesion either by allowing for additional surface area or, in some embodiments, by creating features that entrap deposited Traces that are formed upon them.

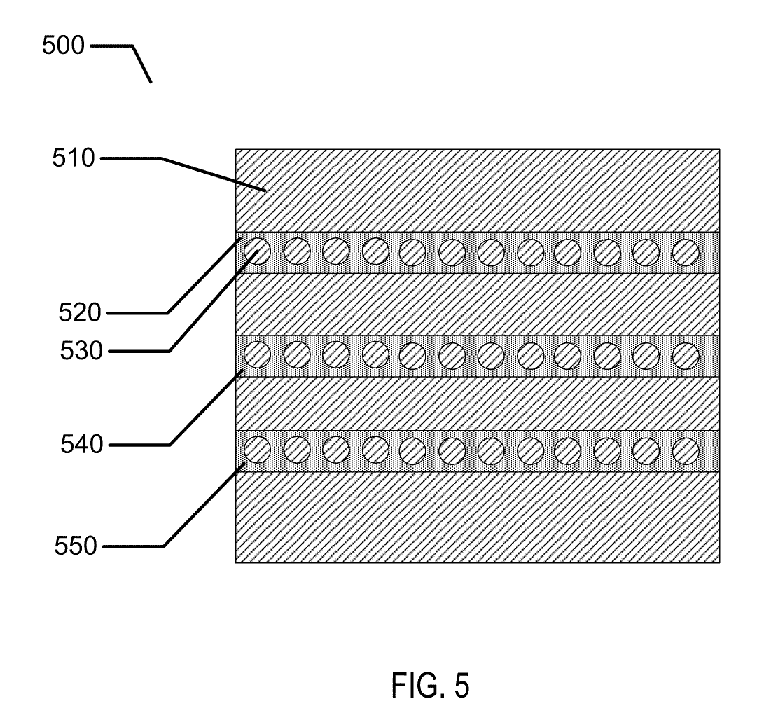

Proceeding to FIG. 5, an exemplary design 500 of metal Traces 520, 540 and 550 upon a Three-dimensional Substrate 510 is depicted. In some embodiments, the metal Traces 520, 540, and 550 may be formed to include areas without metal, such as, for example, circular spaces 530. These spaces 530 without metal may be accomplished through additive means, in some embodiments, where the circular spaces 530 may be screened out during the formation process for the Traces 520, 540, and 550. In some alternative embodiments, by a subtractive process, the spaces 530 may be formed after the application of the Traces 520, 540, and 550 where a subtractive removal step, such as removal etch, may create the spaces 530.

In some embodiments, the edge of the spaces 530 without metal may not be vertical and may be undercut or retrograde, for example. Isotropic etch chemistry, especially where the metal Trace is formed from a stack of different metallurgies, may result in a ledge protruding over the edge profile. In embodiments where the subsequent Trace material is applied by printing means, the subsequent layer material may be flowed under the ledge and may result in a better adherence means. It will be apparent to one skilled in the art that many different designs of protrusions and depressions may be practical to improve adhesion characteristics and are well within the scope of the inventive art herein.

### Methods of Forming Energization Elements on Three-Dimensional Surfaces

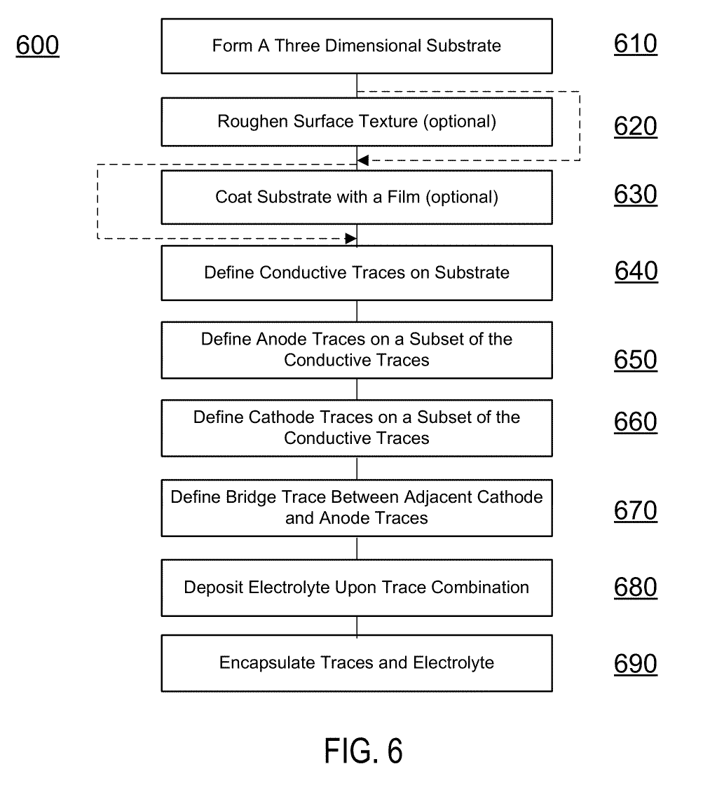

Proceeding to FIG. 6, an exemplary flowchart 600 illustrates a process of forming energization elements on a Three-dimensional Substrate. The order of the steps is provided for exemplary purposes only, and other orders are still within the scope of the invention described herein. At 610, the formation of the Three-dimensional Substrate may occur. In some embodiments, the Three-dimensional Substrate formed at 610 may be the foundation for the energization elements created and added in subsequent steps.

In some embodiments, at 620, the surface of the Three-dimensional Substrate may be optionally roughened, for example, to increase the adhesive properties of the surface. Exemplary means to roughen the surface may include, for example, techniques that physically abrade the surface. Other means may include gas or liquid phase etching processing. A roughened surface in some embodiments may have desirable adhesion characteristics due to either or both the altered surface chemistry or the increase in physical surface area. In some embodiments, this step may be combined with the formation at 610 where the surface may be roughened during the substrate molding process by providing roughened mold tooling where injection molding or cast molding is used to form the substrates. In some embodiments, at 630, a deposit may be optionally deposited upon the surface of the substrate.

At 640, conductive Traces may be placed upon the Three-dimensional Surface. Numerous methods may be used to define the conductive Traces, including for example, shadow mask deposition of metal conductive Traces, photolithography subtractive etch of metal deposits, or direct ablative means for subtractive etch processing. In some embodiments, there may be methods of depositing the conductive Traces by the printing of conductive pastes formed from adhesives and metal flake mixtures. For example, using an nScrypt™ printing unit and an engineered fluid dispensing or EFD-type tip, a silver-based paste, such as, for example, Du Pont 5025 silver conductor, may be applied at 640 to define conductive Traces.

In some embodiments, after conductive Traces are placed upon the substrate surface, the energization elements may now be formed upon electrical Traces. At 650, Anode Traces may be placed near, upon, or partially upon one of the conductive Traces that have been formed. At 650, some embodiments may use the same exemplary or similar printing unit as used at 640 to apply a zinc-based formulation to define Anode Traces. Table 1 provides further examples of formulations that may be appropriate for the formation of the Anode at 650.

At 660, in some embodiments, Cathode Traces may be placed near, upon, or partially upon one of the conductive Traces that have been formed. Table 2 provides examples of formulations that may be appropriate for the formation of the Cathode at 660. At 670, in some embodiments, bridge Traces may be placed near, upon, or partially upon one of the conductive Traces or one or both of the Anode and Cathode Traces that have been formed. Table 3 provides example of formulation that may be appropriate for the formation of the bridge at 670.

In some embodiments, the method of forming the Anode Trace, Cathode Trace, and the bridge at 650-670 may include, for example, additive techniques such as masking or plating techniques, subtractive processing, and printing technology. The printing means and energization elements herein described are illustrated for exemplary purposes only, and one ordinarily skilled in the art will recognize that means and elements other than those discussed may also be included within the scope of the invention. For example, in some alternatives, it may be possible to deposit an Anode layer across the entire Three-dimensional Surface. In other alternative embodiments, subtractive processing methods, such as, for example, lithography processes and subtractive etch processing, may be used to remove the Deposit except where desired. In still further embodiments, the printing means may include a combination of subtractive and additive techniques, such as, for example, where the Anode and Cathode layers are deposited as layers and subtractively removed while the bridge component may be formed by a printing process as an example.

The order of the steps to add the Anode Trace, Cathode Trace, and the bridge may depend on the particular embodiment. For example, in some embodiments, a bridge layer may be first deposited between and/or partially upon the metal Traces to provide for better adhesion and to isolate the Anode from the Cathode, particularly if the printable composition used is prone to spreading. One ordinarily skilled in the art will recognize that formulations and Anode chemistry other than those discussed may also be included within the scope of the invention.

In some embodiments, at 680, an electrolyte that may typically be in a liquid, gelatinous or in some cases polymeric form may be applied. At 690, the formed energization elements and conductive Traces may need to be sealed into an isolated element from other components. Depending on the nature of the electrolyte composition, the order of the steps may be reversed. An encapsulating material may be formed and sealed around the energization element with conductive Traces protruding through the encapsulation material. In some embodiments where the encapsulating process is performed first, the injection of a liquid electrolyte through the encapsulating material or through a defined filling feature formed into the encapsulating material may be used. In these embodiments, after the liquid electrolyte is filled, the region in the encapsulating material that the filling occurred through may also be sealed. It may be apparent to those ordinarily skilled in the art that encapsulation processes and electrolyte applications other than those described may be practical and are considered well within the scope of the art herein.

An Embodiment of an Ophthalmic Lens with Energization Elements on Three-Dimensional Surfaces

In the prior discussion, a number of embodiments of the inventive art have been described. It may be illustrative to consider an exemplary embodiment for an ophthalmic Lens with energization elements on Three-dimensional Surfaces. For this embodiment, a specific type of ophthalmic Lens may be considered where a contact Lens is assembled from a cast-molded hydrogel “skin” surrounding an Energized media insert and where the insert contains electronics, an energization source, and elements capable of changing the focal characteristics of the contact Lens device based on a control signal. The media insert may be formed of a semi-rigid polymer material, which may be formed in two halves. A top half of the insert may contain the front surface where the front is indicated as the portion of the insert that is further from a user's eye surface.

This half of the media insert may have the electronics circuits adhered to its surface. Electrical interconnects that provide low resistance paths to interconnect devices to each other may be deposited between the front portion of the media insert and the adhered electronic circuit. The front half of the media insert may be formed into a varied Three-dimensional Surface as shown, for example, in FIG. 1.

For optimal adhesion of electrical interconnects to this media insert half, the Three-dimensional Surface of the media insert may be coated with a thin parylene-c Deposit layer. To one ordinarily skilled in the art, other types and variants of parylene may be practical and are considered within the scope of the invention described herein. Subsequently, electrical interconnects may be deposited onto this parylene layer on the inner portion of this variable Three-dimensional Surface. In this exemplary embodiment, the electrical interconnects are first deposited by sputter deposition of a metallic Deposit, or stack of Deposits, through a shadow mask and onto the parylene layer in specific locations. The shadow mask process may define electrical Traces that have regions missing in a generally circular pattern, especially in regions where the battery Traces may be made.

Subsequently, a paste containing Binders and solvents into which silver flakes may have been added may be printed into features on the electrical interconnects that were deposited on the Three-dimensional Substrate. The paste with silver flakes may be applied by a printing apparatus to cover the electrical interconnects in regions where batteries may be formed. These adhesive-based silver electrical layers may be printed using a print head configured for Traces of around 200-400 microns width. This width may be chosen to ensure that the underlying electrical Trace may be sufficiently covered by the adhesive formulation.

A portion of the conductive Trace-coated electrical interconnects may be located on a peripheral region of the media insert front surface, and a Deposit, or layers of Deposits, may be printed to form a portion of an alkaline cell onto this peripheral region. The first Deposit to be printed may be the Anode Trace that overlaps one of the electrical interconnect Traces. The Anode Traces may be printed using a print head configured for Traces using the formulations in Table 1. In some embodiments, the Anode Trace may be printed to locate in positions overlapping Traces 140 and 180 in FIG. 1.

In a next processing step, the Cathode portions of the battery may be formed. This Cathode Trace may be printed using a print head configured for Traces using the formulations in Table 2. The Cathode Trace may be printed to locate in position overlapping Traces 130 and 170 in FIG. 1. In embodiments with these configurations, the two battery cells may be located in a parallel configuration to generate a nominal initial battery potential load.

At 680, the bridge portion of this laterally deployed battery cell may be printed. In some embodiments, this is where liquid electrolyte may be imbibed into the porous and optionally gellable structures of Cathode, bridge, and Anode. The bridge Trace may be printed, for example using a print head configured for the formulation in Table 3. In some embodiments, the bridge Traces may be printed to overlap each of the Anode and Cathode Traces and the region in between the Cathode and Anode Traces in the locations where the Anode and Cathode Traces lie next to each other.

At 690, in exemplary embodiments, regions around the battery Traces may be Encapsulated by a thin layer of polymeric material that may be both adhesively sealed, and in some embodiments thermo-welded into location. This thin layer functions to contain the battery electrolyte to be located around the Anode, Cathode, and bridge regions. When the second half of the media insert is sealed to the first half, a media insert may be formed that includes the battery. In some embodiments, the second seal may define and additionally provide a second sealing layer for containment of the battery chemistry.

In other embodiments, a liquid or gelled electrolyte formulation may be added to the sealed battery element. To perform this filling step, a set of needles may penetrate the thin polymeric layer. For example, one of the needles may function to fill the electrolyte into the battery region, and the other may allow for an equivalent volume of ambient gas in the battery region to escape during the filling. In some embodiments, the battery region may be filled to approximately 95% of its volume with gelled liquid electrolyte. On refraction of the filling needles, the penetration locations may be sealed by application of an adhesive sealant into and on the penetration regions by a set of collocated needles to dispense the adhesive. Further, in some embodiments, after the Traces and electrolyte are Encapsulated, a second Encapsulant, such as parylene, for example, may also be used.

An integrated circuit functional to control all the various functions of the contact Lens with active focal changing elements may be attached to the electrical interconnections 150 and 160 in FIG. 1. In some embodiments, the circuit may include a triggering mechanism that may not connect the internal circuitry to the battery until the triggering event occurs so that there is minimal to no draw on the battery until it is needed. In some embodiments, the element that may control the active focal adjustment may be added to the half of the media insert and may be connected to the electrical interconnects. The electrical interconnects that it attaches to may typically be connected to output connection points for the integrated circuit.

After these connections are made, the ophthalmic element may be tested by electrically connecting signals to the electrical interconnects that are connected to the active focal adjustment element. Next, in some embodiments, the second half of the media insert may be sealed to the first half forming a self-powered fully formed media insert. After the insert is formed inside an ophthalmic Lens, a wearable contact Lens with Energized function to adjust focal characteristics of the contact Lens may result.

Specific examples have been described to illustrate aspects of inventive art relating to the formation, methods of formation, and apparatus of formation that may be useful to form energization elements upon electrical interconnects on Three-dimensional Surfaces. These examples are for said illustration and are not intended to limit the scope in any manner. Accordingly, the description is intended to embrace all embodiments that may be apparent to those skilled in the art.

1. A method of forming an Energized insert on a Three-dimensional Substrate for an ophthalmic Lens, the method steps of:
forming a Three-dimensional Substrate base of suitable size for inclusion in an ophthalmic Lens from a first insulating material;
defining conductive Traces on said substrate base;
forming energization elements on a first portion of the conductive Traces, wherein said energization elements are comprised of a first Anode Trace and at least a first Cathode Trace;
applying electrolyte upon energization elements; and
encapsulating said energization elements and electrolyte.

2. The method of claim 1, additionally comprising:
modifying a first portion of a first surface of said substrate base to increase surface area of said first portion.

3. The method of claim 1, additionally comprising:
modifying a first portion of a first surface of said substrate base to alter the surface chemistry of said first portion.

4. The method of claim 2, wherein the modification of the first surface of the substrate base includes roughening the surface to form textured patterns.

5. The method of claim 1, additionally comprising the step of:
coating the substrate base with at least a first layer of parylene.

6. The method of claim 5, wherein the parylene is parylene-C.

7. The method of claim 1, wherein the Three-dimensional Substrate forms part of a media insert that can be incorporated in a hydrogel ophthalmic Lens.

8. The method of claim 1, wherein the conductive Traces are formed using printing techniques.

9. The method of claim 8, wherein the printing techniques include moving the substrate base in relation to a depositing tip used in the printing technique.

10. The method of claim 8, wherein the printing techniques include moving the depositing tip used in the printing technique in relation to the substrate base.

11. The method of claim 1 further comprising:
forming a first bridge Trace between portions of the Anode Trace and the Cathode Trace.

12. The method of claim 1, wherein the conductive Traces are formed using additive lithographic techniques.

13. The method of claim 12, wherein the lithographic techniques further includes subtractive processing methods.

14. The method of claim 1, wherein the encapsulation material is parylene.

15. The method of claim 14, wherein the encapsulation material is parylene-C.

16. The method of claim 1, wherein the conductive Traces protrude through the encapsulation material.

17. The method of claim 1, wherein the electrolyte is applied through injection means through the encapsulation material after the encapsulation of the energization elements occurs.

18. The method of claim 1, wherein the encapsulation of the energization elements occurs prior to the application of the electrolyte, and wherein the electrolyte is applied onto a filling feature formed into the encapsulation material.

19. The method of claim 18 further comprising the steps of:
sealing the filling feature.
